(19) United States
(12) Patent Application Publication
(10) Pub. No.: US 2023/0270618 A1
(43) Pub. Date: Aug. 31, 2023

(54) CONTROL METHOD FOR INTELLIGENT ROLLATOR, AND A CONTROL DEVICE, AN INTELLIGENT ROLLATOR, A CONTROLLER THEREOF

(71) Applicant: ZHEJIANG YIHENGYUE MEDICAL TECHNOLOGY CO., LTD., Taizhou City, Zhejiang Province (CN)

(72) Inventors: Mao GONG, Taizhou City, Zhejiang Province (CN); Jianfeng LU, Taizhou City, Zhejiang Province (CN)

(21) Appl. No.: 18/016,240

(22) PCT Filed: Jul. 9, 2021
(86) PCT No.: PCT/CN2021/105444

§ 371 Date: Jan. 13, 2023

(30) Foreign Application Priority Data
Jul. 1, 2021 (CN) 202110747593.8

(51) Int. Cl. A61H 3/04; G05B 13/02

(52) U.S. Cl. CPC A61H 3/04; G05B 13/0265; A61H 2003/043; A61H 2003/001

(57) ABSTRACT

A control method for an intelligent rollator, and a control device, an intelligent rollator, a controller thereof. The intelligent rollator is configured with a vehicle body, a front wheel and rear wheels driven by a motor. The method includes the following steps: obtaining the moving speed of the intelligent rollator; obtaining the attitude of the intelligent rollator; and reducing the torque output of the motor, when the attitude indicates that the front end of the intelligent rollator is tilted upward, and the moving speed of the intelligent rollator is less than a first threshold. The intelligent rollator can determine whether it is necessary to enter an intelligent crossing-curb mode, in which the torque output of the motor is reduced, so as to prevent the vehicle body out of control due to the increase of torque caused by the too large speed when getting over curbs.

### CROSS-REFERENCE TO RELATED APPLICATIONS

This application claims priority to PCT Application No. PCT/CN2021/105444 filed on Jul. 9,2021, which claims priority to Chinese Patent Application No. 202110747593.8 filed on Jul. 1, 2021. The entire contents both of which are hereby incorporated by reference.

### FIELD OF TECHNOLOGY

The present application relates to the technical field of intelligent walking aids, in particular to a control method for an intelligent rollator, and a control device, an intelligent rollator a controller thereof.

### BACKGROUND

With the progress of the times, there are a large number of intelligent wheeled walkers or rollators for the elderly, such as electric wheelchairs and shopping strollers.

Wheelchairs are generally divided into two categories, one is the electric wheelchair that needs to be pushed by caregivers, and the other is the electric wheelchair that can be controlled by the rider. Manual wheelchair users are generally the ones who have lost some of their mobility with their hands and legs, while electric wheelchair users are elderly and disabled people with normal hands and partial loss of mobility with their legs, who can control the wheelchair with a rocker.

Shopping strollers generally have the functions of loading goods and assisting walking. They are widely used in developed countries such as Europe, America, Japan and South Korea etc. The users are the elderly or people having certain mobility with their legs. Shopping strollers require users to push for moving.

The above-mentioned intelligent rollators are usually used on sidewalks. Due to lack of enough barrier-free access in most countries, there is often a curb of 10-20 cm high between a sidewalk and a highway, which is difficult for rollators to get over. In this regard, the typical wheeled walkers or rollators have difficulty in smooth transition over irregular terrain, which is very inconvenient for the elderly or mobility-impaired people, especially.

### SUMMARY

Therefore an object of the present application is to provide a control method for an intelligent rollator, and a control device, an intelligent rollator, a controller thereof, wherein the intelligent rollator can determine whether it is necessary to enter an intelligent crossing-curb mode, in which the torque output of the motor is reduced, so as to prevent the rollator out of control due to the increase of torque caused by the too large speed when getting over curbs.

According to a first aspect of embodiments of the present application, there is provided a control method for an intelligent rollator having a vehicle body, a front wheel and rear wheels driven by a motor. The method includes the following steps:

obtaining the moving speed of the intelligent rollator;

obtaining the attitude of the intelligent rollator; and

reducing the torque output of the motor, when the attitude indicates that the front end of the intelligent rollator is tilted upward, and the moving speed of the intelligent rollator is less than a first threshold.

Optionally, the attitude indicates that the front end of the intelligent rollator is tilted upward, when the intelligent rollator meets at least one of the following conditions:

The upward tilt angle of the intelligent rollator exceeds a preset second threshold; The change of the upward tilt angular velocity of intelligent rollator exceeds a preset third threshold.

Optionally, after reducing the torque output of the motor, the method further includes the following step:

controlling the torque output of the motor according to the upward tilt angle of the intelligent rollator, the larger the angle, the larger the torque output.

Optionally, the method further includes the following step:

reducing or stopping increasing the torque output of the motor if the upward tilt angle of the intelligent rollator is greater than a preset maximum threshold.

Optionally, the method further includes the following steps:

recording the upward tilt angle of the intelligent rollator as a first angle;

recording the angle before the intelligent rollator tilts upward as a second angle;

recording the maximum angle at which the intelligent rollator tilts upward as a third angle; and

increasing the torque output of the motor when the first angle is greater than the second angle and the first angle is smaller than the third angle.

Optionally, after increasing the torque output of the motor, the method further includes the following step:

reducing the torque output of the motor, when the upward tilt angle of the intelligent rollator is smaller than the first angle and the upward tilt angular velocity of intelligent rollator is zero.

Optionally, before reducing the torque output of the motor, the method further includes the following step:

entering an intelligent crossing-curb mode.

According to a second aspect of embodiments of the present application, there is provided a control method for an intelligent rollator having a vehicle body, a front wheel and rear wheels driven by a motor. The method includes the following steps:

entering an intelligent crossing-curb mode according to preset trigger command;

obtaining the moving speed of the intelligent rollator;

obtaining the attitude of the intelligent rollator; and

controlling the torque output of the motor according to the upward tilt angle of the intelligent rollator, the larger the angle, the larger the torque output, when the attitude indicates that the front end of the intelligent rollator is tilted upward, and the moving speed of the intelligent rollator is less than a first threshold.

According to a third aspect of embodiments of the present application, there is provided a control device for an intelligent rollator having a vehicle body, a front wheel and rear wheels driven by a motor. The device includes:

a first movement speed acquisition module for obtaining the moving speed of an intelligent rollator;

a first attitude acquisition module for obtaining the attitude of an intelligent rollator; and

a first torque output module for reducing the torque output of the motor, when the attitude indicates that the front end of the intelligent rollator is tilted upward, and the moving speed of the intelligent rollator is less than a first threshold.

According to a forth aspect of embodiments of the present application, there is provided a control device for an intelligent rollator having a vehicle body, a front wheel and rear wheels driven by a motor. The device includes:

a second mode switch module for entering an intelligent crossing-curb mode according to preset trigger command;

a second movement speed acquisition module for obtaining the moving speed of an intelligent rollator;

a second attitude acquisition module for obtaining the attitude of an intelligent rollator; and

a second torque output module for controlling the torque output of the motor according to the upward tilt angle of the intelligent rollator, the larger the angle, the larger the torque output, when the attitude indicates that the front end of the intelligent rollator is tilted upward, and the moving speed of the intelligent rollator is less than a first threshold.

According to a fifth aspect of embodiments of the present application, there is provided an intelligent rollator, which includes:

at least one memory and at least one processor;

one or more programs stored in the memory,

wherein the one or more programs are executed by the at least one processor to implement the steps of a control method for an intelligent rollator according to the first and second aspects of the present application.

According to a sixth aspect of embodiments of the present application, there is provided a controller, which includes:

at least one memory and at least one processor;

one or more programs stored in the memory,

wherein the one or more programs are executed by the at least one processor to implement the steps of a control method for an intelligent rollator according to the first and second aspects of the present application.

In the embodiments of the present application, determination of whether the intelligent rollator needs to enter the intelligent crossing-curb mode is intelligently made by combining the upward tilt angle of the vehicle body, the angular velocity changes, and the speed change of the vehicle body. In the intelligent crossing-curb mode, the torque output of the motor is controlled according to the upward tilt angle of the vehicle body, which avoids the situation that the vehicle body is out of control due to the increase of torque caused by the excessive speed when crossing. In addition, through recording the change of the upward tilt angle of the intelligent rollator during crossing, after the front wheel has crossed the curb, when the upward tilt angle becomes smaller and the angular velocity is zero, it is determined that the rear wheels of the intelligent rollator also have completed crossing the curb, therefore the torque output of the motor is reduced, so that the intelligent rollator will not suddenly accelerate due to the large torque output of the motor after crossing the curb. In such a way, the intelligent rollator can cross the curb more smoothly, which increases the safety of the intelligent rollator. Meanwhile, whether the front wheel has crossed the curb is intelligently determined when it is detected that the angle is smaller than the maximum angle and the angular velocity is zero during the process of the front wheel crossing the curb. In order to illustrate the embodiments of the present application or the technical solutions in the prior art more clearly, below is a brief introduction of the accompanying drawings required for the description of the embodiments of the present application. It is evident that the accompanying drawings in the following description are only some embodiments of the present application. It will be appreciated by persons skilled in the art that other drawings can be obtained based on these drawings without any creative effort.

### BRIEF DESCRIPTION

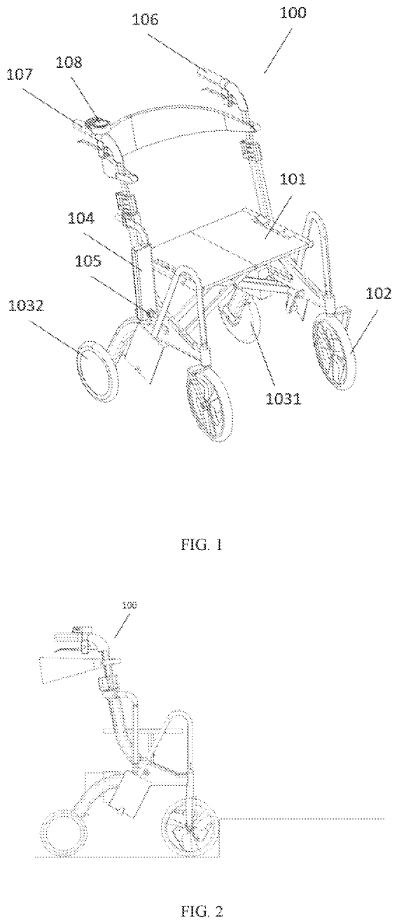

FIG. 1 is a schematic structural view of an intelligent rollator according to some embodiment of the present application;

FIG. 2 is a schematic view of an intelligent rollator according to some embodiment of the present application when getting over a bump;

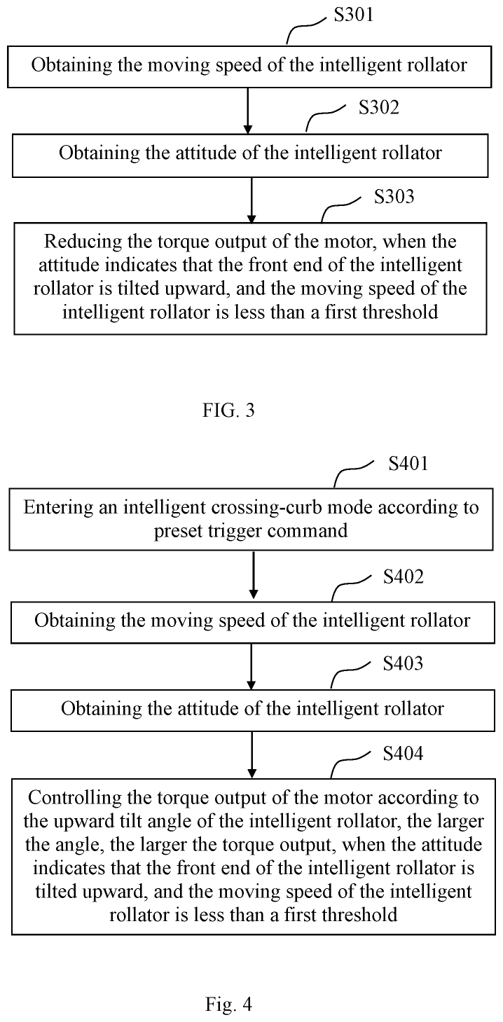

FIG. 3 is s a flow diagram of a control method for intelligent rollators according to some embodiment of the present application;

FIG. 4 is s a flow diagram of a control method for intelligent rollators according to some embodiment of the present application;

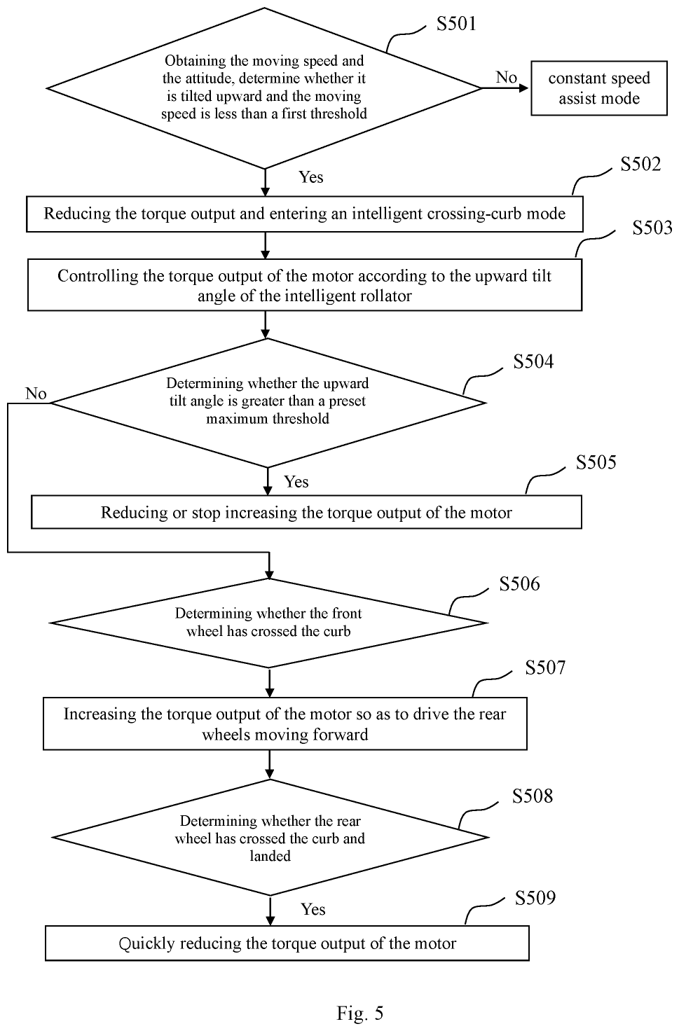

FIG. 5-8 are schematic views of an intelligent rollator according to some embodiment of the present application when getting over a bump;

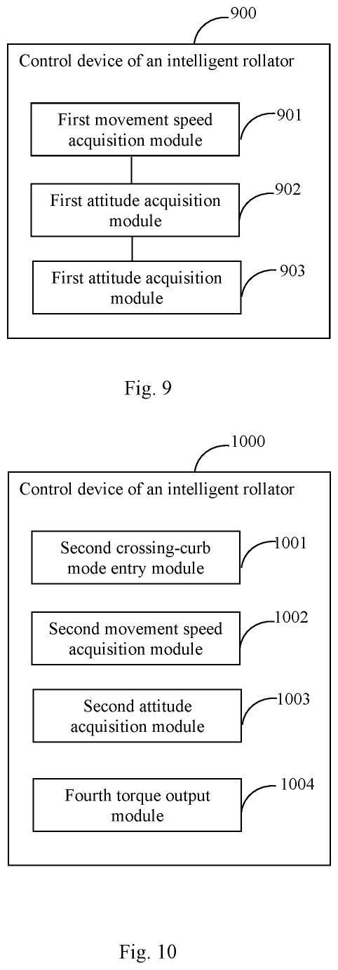

FIG. 9 is a schematic structural view of a control device of intelligent rollators according to some embodiment of the present application;

FIG. 10 is a schematic structural view of a control device of intelligent rollators according to some embodiment of the present application;

Designations: 100—intelligent rollator; 101—seat; 102—driven wheel; 1031—first rear wheel; 1032—second rear wheel; 104—horizontal armrest; 105—intelligent front control device; 106—first horizontal handle; 107—second horizontal handle; 108—intelligent rear control device

### DETAILED DESCRIPTION

In order to make the object, technical scheme and advantages of this application more clear, the embodiments of the present application will be described in further detail below with reference to the accompanying figures.

It will be appreciated that the described embodiments are only a part of the embodiments of the present application, rather than all the embodiments. Based on the embodiments described in the present application, persons of ordinary skill in the art can obtain all other embodiments without creative work, which are all within the protection scope of the embodiments of the present application. The above mentioned is only the implementation method of the present application, and is not intended to limit the scope of the present application. Any equivalent structure or equivalent process transformation using the contents of the specification of the present application and the accompanying drawings, or any direct or indirect application in other related technical fields, is included in the protection scope of the present application.

The terminology used herein is for the purpose of describing particular embodiments only and is not intended to be limiting of the application. As used herein, the singular forms “a,” “an,” and “the” are intended to include the plural forms as well as the singular forms, unless the context clearly indicates otherwise. It will be further appreciated, the term “and/or” includes any and all combinations of one or more of the associated listed items.

Where the following description refers to the figures, like designations denote like members in different figure unless otherwise indicated. The implementations described in the illustrative embodiments below are not intended to represent all implementations consistent with this application. Rather, they are merely examples of apparatus and methods consistent with some aspects of the present application, as recited in the appended claims. In the description of this application, it will be appreciated that the terms “first”, “second”, “third”, etc. are only used to distinguish similar objects, and are not necessarily used to describe a specific order or sequence, nor as indicating or implying relative importance. For those of ordinary skill in the art, the specific meanings of the above terms in this application can be understood according to specific situations.

Also, in the description of the present application, unless otherwise specified, “a plurality” means two or more. “And/or”, which describes the relationship between related objects, means that there can be three kinds of relationships, for example, A and/or B, which can mean that A exists alone, A and B exist at the same time, and B exists alone. The character “/” generally indicates that the related objects are an “or” relationship.

An intelligent rollator described in this application embodiment can specifically be an electric wheelchair, a shopping stroller, a cart, etc. The intelligent rollator has front and rear wheels, and the rear wheels are driven by an electric motor, as shown in FIG. 1. As an example of a multifunctional walking aid, the intelligent rollator can be used as an electric wheelchair, a shopping stroller or a cart to carry items.

As shown in FIG. 1, the intelligent rollator 100 includes a vehicle body configured with a seat 101 for a person to sit or place items on, a front wheel, i.e., a driven wheel 102 at the front end of the vehicle body without power output, and a first rear wheel 1031 and a second rear wheel 1032 at the rear end of the vehicle body, wherein the first rear wheel 1031 and the second rear wheel 1032 are each driven by a different motor. In some other embodiments, the first rear wheel 1031 and the second rear wheel 1032 may be driven by the same motor.

Preferably, the intelligent rollator 100 is configured with a front control unit used by a rider and a rear control unit used by a walker. Specifically, the vehicle body is configured with a horizontal armrest 104 (in a stowed position in FIG. 1), and the front end of the armrest 104 is configured with an intelligent front control device 105. Preferably, the intelligent front control device 105 is configured with a rocker that can be swung 360° horizontally, as well as a plurality of buttons and displays, etc., for the operation of the multi-function walker.

The rear side of the vehicle body is further configured with a first horizontal handle 106 and a second horizontal handle 107 for hand-holding, and the second horizontal handle 107 is provided with an intelligent rear control device 108. Preferably, the intelligent rear control device 108 consists of an LCD screen, a constant speed finger rest, a sign sensing module, buttons, a posture sensing device, an intelligent rear control bracket and an intelligent rear control unit. The buttons include an on/off button, a direction switching button, a power assist level switching button, the LCD screen displays speed, gear, remaining power and a multi-function display, wherein the constant speed finger rest can control the intelligent walker to run at a set gear speed at a constant speed during touch, and the intelligent rear control unit is fixed to the front of the second horizontal handle by the intelligent rear control bracket.

In this embodiment, the intelligent rollator can be operated by the intelligent front control device 105 or the intelligent rear control device 108, which is respectively configured with a control chip to control the intelligent rollator. The intelligent rollator includes a normal mode and a constant speed assist mode. The different speed gears in the constant speed assist mode can be set by the intelligent front control device 105 or the intelligent rear control device 108. When a certain speed gear is selected, the intelligent rollator will move evenly in the constant speed assist mode to assist walking.

In some embodiments, the intelligent rollator can automatically enter the constant speed assist mode according to some preset determination modes, or it can be manually selected to enter the constant speed assist mode, for example, by touching the constant speed finger rest of the intelligent rear control device 108.

The operating principle of the above constant speed assist mode is that, according to the preset speed, the current speed is collected, and the torque output of the rear wheel motor is controlled through feedback, so that the moving speed of the intelligent rollator is equal to the preset speed.

Users cannot lift the front wheels of manual wheelchairs to cross a curb because they are too heavy. While the intelligent rollator with constant speed assist mode is crossing a curb as shown in FIG. 2, the control process is as follows: the caregiver pulls the first horizontal handle 106 and the second horizontal handle 107; the motor detects that the movement speed decreases and then increases the torque output to make the front wheels lift; because the movement speed of the motor decreases at the moment, even to zero, the feedback control program to realize the motor torque control will keep increasing the torque output of the motor, thus the intelligent rollator may roll over or lose control.

Regarding to above-mentioned problem, the present application provides a control method for an intelligent rollator, which can make the intelligent rollator get over curbs smoothly. The control method is carried out by the intelligent front control device 105 or the intelligent rear control device 108 in FIG. 1. In other embodiments, the control method can further be applied to any intelligent walker with front wheels and electric rear wheels.

A curb in the embodiment of this application, as shown in FIG. 2, refers to the appearance of a naturally formed or artificially constructed step-like shape on the pavement that is originally level or has a certain slope, and the pavement above the step-like shape is higher than the pavement below it.

In this embodiment, crossing a curb is getting over the edge of a road to reach a sidewalk that is one step higher than the height of the road.

In this embodiment, the automation crossing-curb mode control method as shown by FIG. 3 includes steps as follows:

S301: Obtaining the moving speed of the intelligent rollator.

S302: Obtaining the attitude of the intelligent rollator.

S303: Reducing the torque output of the motor, when the attitude indicates that the front end of the intelligent rollator is tilted upward, and the moving speed of the intelligent rollator is less than a first threshold.

The above-mentioned attitude of the intelligent rollator is used to characterize the motion attitude of the intelligent rollator, which is usually detected by an attitude sensor. Attitude sensors usually include auxiliary motion sensors such as three-axis gyroscopes, three-axis accelerometers, and three-axis electronic compasses. The attitude sensor outputs the calibrated angular velocity, acceleration, etc. through the embedded low-power ARM processor, performs motion attitude measurement through the sensor data algorithm based on quaternion, and outputs real-time 3D posture data with zero drift, including quaternion, Euler angle, etc.

In this embodiment, the vehicle body in FIG. 1 is further provided with an attitude detection module, which is used to detect the angular change and the angular velocity change of the vehicle body, and respectively send them to the intelligent front control device 105 or the intelligent rear control device 108.

When the intelligent rollator meets at least one of the following conditions, the attitude indicates that the front end of the intelligent rollator is tilted upward:

The upward tilt angle of the intelligent rollator exceeds a preset second threshold; The change of the upward tilt angular velocity of intelligent rollator exceeds a preset third threshold.

The first threshold, the second threshold and the third threshold are thresholds preset in the intelligent front control device 105 or the intelligent rear control device 108 in FIG. 1.

As the constant speed assist mode will cause the motor torque output too large when the intelligent rollator lifts the front wheel to start crossing the curb, therefore in embodiments of the present application, once the front end of the intelligent rollator is detected tilted upward, the torque output of the motor is reduced immediately to prevent rolling over of the intelligent rollator. Preferably, the torque output of the motor is not randomly or quantitatively reduced, but a torque control mode for the motor is switched to, which controls the torque output of the motor according to the upward tilt angle of the intelligent rollator, the larger the angle, the larger the torque output.

In other words, after it is detected that the front end of the intelligent rollator is tilted upward, the torque control method for the motor is switched from according to the moving speed of the intelligent rollator to according to the upward tilted angle of the intelligent rollator, and to reduce the torque output of the motor to the value corresponding to the upward tilted angle of the intelligent rollator.

Preferably, before reducing the torque output of the motor, the method further includes the following step:

Entering an intelligent crossing-curb mode.

In other words, the present application further includes an intelligent crossing-curb mode, to realize that the torque output of the motor is controlled according to the upward tilted angle of the intelligent rollator.

In this embodiment, the intelligent crossing-curb mode is automatically triggered by obtaining the angle, angular velocity and moving speed and their changes thereof to determine whether the intelligent rollator starts getting on a curb. In other embodiments, an intelligent crossing-curb mode may be triggered manually before the front end of the intelligent rollator is lifted.

In this regard, in some embodiment as shown in FIG. 4, the control method for the intelligent rollator includes the following steps:

S401: Entering an intelligent crossing-curb mode according to preset trigger command.

S402: Obtaining the moving speed of the intelligent rollator.

S403: Obtaining the attitude of the intelligent rollator.

S404: Controlling the torque output of the motor according to the upward tilt angle of the intelligent rollator, the larger the angle, the larger the torque output, when the attitude indicates that the front end of the intelligent rollator is tilted upward, and the moving speed of the intelligent rollator is less than a first threshold.

For the case when crossing the curb which is too high, the intelligent rollator may tilt too large angle and fall, some embodiment further includes the following step:

When the upward tilt angle of the intelligent rollator is greater than a preset maximum threshold, the torque output of the motor is reduced or stopped increasing, and the user can choose to give up crossing the curb.

Preferably, some embodiment of the present application may further determine whether the front wheel of the intelligent rollator has crossed the curb. Specifically, the control method further includes the following steps:

recording the upward tilt angle of the intelligent rollator as a first angle;

recording the angle before the intelligent rollator tilts upward as a second angle;

recording the maximum angle at which the intelligent rollator tilts upward as a third angle; and

increasing the torque output of the motor so as to drive the rear wheels moving forward, when the first angle is greater than the second angle and the first angle is smaller than the third angle,

When the front wheel of the intelligent rollator is crossing the curb, the lifting front wheel usually raises to a height slightly higher than the height of the curb before descending to the curb. Therefore, the embodiment of this application records the maximum angle of the intelligent rollator tilting upward, and if the current angle is less than this maximum angle and greater than the angle before tilting upward, the intelligent rollator can be determined to be at the stage where the front wheel has crossed the curb and the rear wheels are moving toward the curb or the rear wheels are lifting, then the torque output of the motor can be increased to make the rear wheels move more powerfully towards the step or lift upwards.

In other embodiments, whether the vehicle body has a forward moving speed can be determined when the upward tilt angle of the intelligent rollator is less than the maximum angle and the angular velocity of intelligent rollator is zero, which can also be used to assist in determining whether the front wheels have completed crossing the curb.

After it is determined that the front wheel has completed crossing the curb, a preferred embodiment of the present application further determines whether the rear wheels have crossed the curb. Specifically, after determining that the front wheel has passed the curb and increasing the torque output of the motor, the method further includes the following step:

reducing the torque output of the motor, when the upward tilt angle of the intelligent rollator is smaller than the first angle and the upward tilt angular velocity of intelligent rollator is zero.

As shown in FIGS. 5-8, combining with the intelligent rollator in FIG. 1, the control method for the intelligent rollator according to embodiments of the present application, when the user pushes the intelligent rollator in a constant-speed assist mode and comes in front of a curb, the intelligent rear control device 108 of the intelligent rollator or the control panel of the intelligent front control device 105 performs the following steps:

S501: Obtaining the moving speed of the intelligent rollator 100, when the user pulls the first horizontal handle 106 and the second horizontal handle 107 to lift the front wheel of the intelligent rollator 100, and obtaining the attitude of the intelligent rollator 100 by determining that the tilt angle of the intelligent rollator 100 exceeds a preset second threshold, and/or that the change in the tilt angular velocity of the intelligent rollator 100 exceeds a preset third threshold.

S502: Reducing the torque output and entering an intelligent crossing-curb mode, when the attitude indicates that the front end of the intelligent rollator 100 is tilted upward, and the moving speed of the intelligent rollator is less than a first threshold, as shown by FIG. 5.

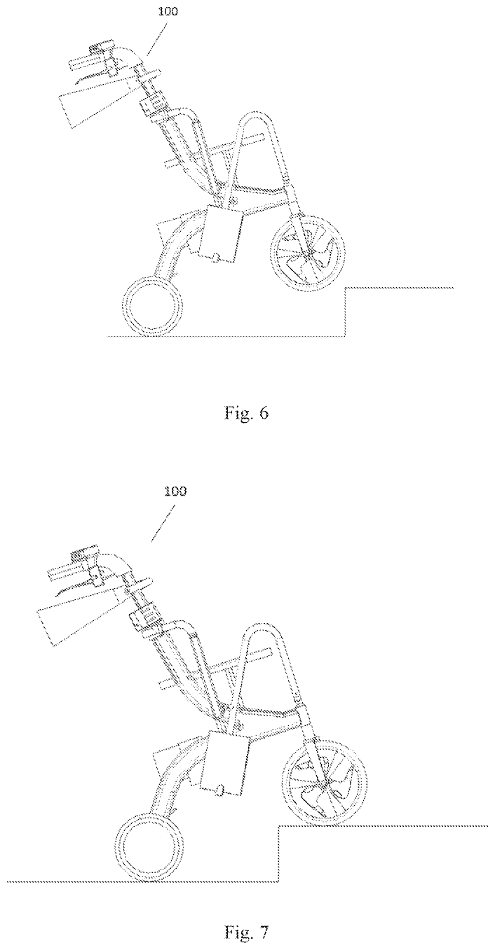

S503: Controlling the torque output of the motor, the larger the angle, the larger the torque output in the process of the front wheel climbing up the curb in FIG. 6.

S504: Determining whether the upward tilt angle of the intelligent rollator 100 is greater than a preset maximum threshold.

S505: If yes, reducing or stop increasing the torque output of the motor; if no, continuing to control the torque output of the motor according to the upward tilt angle.

S506: Determining whether the front wheel has crossed the curb and landed. Specifically, record the upward tilt angle of the intelligent rollator 100 as a first angle; record the angle before the intelligent rollator 100 tilts upward as a second angle; record the maximum angle at which the intelligent rollator 100 tilts upward as a third angle; when the first angle is greater than the second angle and the first angle is smaller than the third angle, it is determined that the front wheel has crossed the curb, wherein the vehicle body is in a state as shown by FIG. 7.

S507: Increasing the torque output of the motor so as to drive the rear wheels moving forward.

S508: Determining whether the upward tilt angle of the intelligent rollator is smaller than the first angle and the upward tilt angular velocity of intelligent rollator is zero.

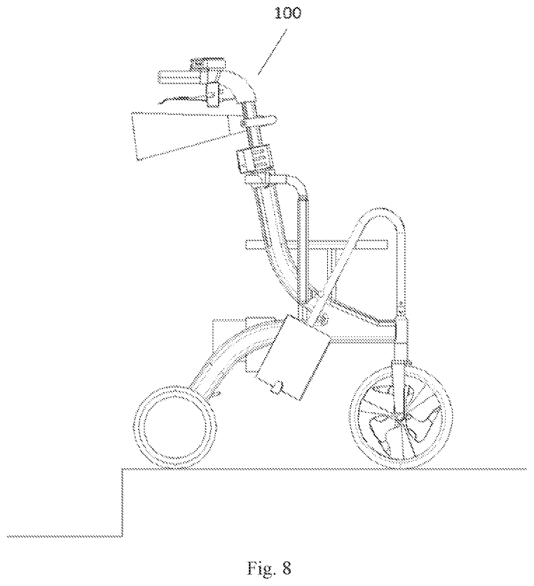

S509: If yes, quickly reducing the torque output of the motor to avoid the forward impact force of the intelligent rollator 100, as it is determined that the rear wheels have crossed the curb, wherein the vehicle body is in a state as shown by FIG. 8.

In this embodiment, the moving speed of the rear wheel is adjusted by adjusting the torque output of the rear wheel motor. When there are multiple rear wheels, and each rear wheel is controlled by a separate motor, the movement speed control of all the rear wheels can be realized by uniformly adjusting the torque output of all the motors. When there are multiple rear wheels and are controlled by the same motor, the moving speed of the multiple rear wheels is controlled by controlling the torque output of the motor.

Whether the front wheel has crossed the curb can be determined automatically or manually by sending a command to the controller of the intelligent rollator. For example, in the embodiment of FIG. 1, it can be by sending a command to the intelligent front control device 105 or the intelligent rear control device 108 to determine that the front wheel has crossed the curb, which can be sent by a button configured on the intelligent front control device 105 or the intelligent rear control device 108.

In the embodiments of the present application, determination of whether the intelligent rollator needs to enter the intelligent crossing-curb mode is intelligently made by combining the upward tilt angle of the vehicle body, the angular velocity changes, and the speed change of the vehicle body. In the intelligent crossing-curb mode, the torque output of the motor is controlled according to the upward tilt angle of the vehicle body, which avoids the situation that the vehicle body is out of control due to the increase of torque caused by the excessive speed when crossing. In addition, through recording the change of the upward tilt angle of the intelligent rollator during crossing, after the front wheel has crossed the curb, when the upward tilt angle becomes smaller and the angular velocity is zero, it is determined that the rear wheels of the intelligent rollator also have completed crossing the curb, therefore the torque output of the motor is reduced, so that the intelligent rollator will not suddenly accelerate due to the large torque output of the motor after crossing the curb. In such a way, the intelligent rollator can cross the curb more smoothly, which increases the safety of the intelligent rollator. Meanwhile, whether the front wheel has crossed the curb is intelligently determined when it is detected that the angle is smaller than the maximum angle and the angular velocity is zero during the process of the front wheel crossing the curb.

In accordance with the above-mentioned control method for an intelligent rollator, some embodiment of the present application further provides a control device 900 of an intelligent rollator as shown in FIG. 9, which includes:

a first movement speed acquisition module 901 for obtaining the moving speed of an intelligent rollator;

a first attitude acquisition module 902 for obtaining the attitude of an intelligent rollator; and

a first torque output module 903 for reducing the torque output of the motor, when the attitude indicates that the front end of the intelligent rollator is tilted upward, and the moving speed of the intelligent rollator is less than a first threshold.

In this embodiment, the attitude indicates that the front end of the intelligent rollator is tilted upward when the intelligent rollator meets at least one of the following conditions:

The upward tilt angle of the intelligent rollator exceeds a preset second threshold; The change of the upward tilt angular velocity of intelligent rollator exceeds a preset third threshold.

In some embodiment, the device further includes:

a second torque output module for controlling the torque output of the motor according to the upward tilt angle of the intelligent rollator, the larger the angle, the larger the torque output, after reducing the torque output of the motor.

In some embodiment, the device further includes:

a tilt protection module for reducing or stopping the increase of the torque output of the motor when the upward tilt angle of the intelligent rollator is greater than a preset maximum threshold.

In some embodiment, the device further includes:

a first angle record module for recording the upward tilt angle of the intelligent rollator as a first angle;

a second angle record module for recording the angle before the intelligent rollator tilts upward as a second angle;

a third angle record module for recording the maximum angle at which the intelligent rollator tilts upward as a third angle; and

a third torque output module for increasing the torque output of the motor, when the first angle greater than the second angle and the first angle smaller than the third angle.

In accordance with the above-mentioned control method for an intelligent rollator, some embodiment of the present application further provides a control device 1000 of an intelligent rollator as shown in FIG. 10, which includes:

a second crossing-curb mode entry module 1001 for entering an intelligent crossing-curb mode according to preset trigger command;

a second movement speed acquisition module 1002 for obtaining the moving speed of an intelligent rollator;

a second attitude acquisition module 1003 for obtaining the attitude of an intelligent rollator; and

a fourth torque output module 1004 for controlling the torque output of the motor according to the upward tilt angle of the intelligent rollator, the larger the angle, the larger the torque output, when the attitude indicates that the front end of the intelligent rollator is tilted upward, and the moving speed of the intelligent rollator is less than a first threshold.

In accordance with the above-mentioned control method for an intelligent rollator, some embodiment of the present application further provides an intelligent rollator, which includes:

at least one memory and at least one processor;

one or more programs stored in the memory,

wherein the one or more programs are executed by the at least one processor to implement the steps of a control method for an intelligent rollator according to any one of the above embodiments.

In accordance with the above-mentioned control method for an intelligent rollator, some embodiment of the present application further provides a controller, which includes:

at least one memory and at least one processor;

one or more programs stored in the memory,

wherein the one or more programs are executed by the at least one processor to implement the steps of a control method for an intelligent rollator according to any one of the above embodiments.

While the present application has been described in conjunction with the specific embodiments outlined above, it is evident that many alternatives, modifications and variations will be apparent to those skilled in the art.

Accordingly, the preferred embodiments of the present application as set forth above are intended to be illustrative, not limiting. It will be appreciated by persons skilled in the art that various changes may be made without departing from the spirit and scope of the invention, as required by the following claims. The claims provide the scope of the coverage of the invention and should not be limited to the specific examples provided herein.

1-12. (canceled)

13. A control method for an intelligent rollator having a vehicle body, a front wheel and rear wheels driven by a motor, comprising the following steps:
obtaining the moving speed of the intelligent rollator;
obtaining the attitude of the intelligent rollator; and
reducing the torque output of the motor, when the attitude indicates that the front end of the intelligent rollator is tilted upward, and the moving speed of the intelligent rollator is less than a first threshold;
reducing or stopping increasing the torque output of the motor if the upward tilt angle of the intelligent rollator is greater than a preset maximum threshold.

14. The control method of claim 13, wherein the attitude indicates that the front end of the intelligent rollator is tilted upward, when the intelligent rollator meets at least one of the following conditions:
the upward tilt angle of the intelligent rollator exceeds a preset second threshold;
the change of the upward tilt angular velocity of intelligent rollator exceeds a preset third threshold.

15. The control method of claim 13, wherein after reducing the torque output of the motor, the method further comprises the following step:
controlling the torque output of the motor according to the upward tilt angle of the intelligent rollator, the larger the angle, the larger the torque output.

16. The control method of claim 13, wherein the method further comprises the following steps:
recording the upward tilt angle of the intelligent rollator as a first angle;
recording the angle before the intelligent rollator tilts upward as a second angle;
recording the maximum angle at which the intelligent rollator tilts upward as a third angle; and
increasing the torque output of the motor when the first angle is greater than the second angle and the first angle is smaller than the third angle.

17. The control method of claim 16, wherein after increasing the torque output of the motor, the method further comprises the following step:
reducing the torque output of the motor, when the upward tilt angle of the intelligent rollator is smaller than the first angle and the upward tilt angular velocity of intelligent rollator is zero.

18. The control method of claim 13, wherein before reducing the torque output of the motor, the method further comprises the following step:
entering an intelligent crossing-curb mode.

19. A control method for an intelligent rollator having a vehicle body, a front wheel and rear wheels driven by a motor, comprising the following steps:
entering an intelligent crossing-curb mode according to preset trigger command;
obtaining the moving speed of the intelligent rollator;
obtaining the attitude of the intelligent rollator; and
controlling the torque output of the motor according to the upward tilt angle of the intelligent rollator, the larger the angle, the larger the torque output, when the attitude indicates that the front end of the intelligent rollator is tilted upward, and the moving speed of the intelligent rollator is less than a first threshold.

20. A control device for an intelligent rollator having a vehicle body, a front wheel and rear wheels driven by a motor, comprising:
a first movement speed acquisition module for obtaining the moving speed of an intelligent rollator;
a first attitude acquisition module for obtaining the attitude of an intelligent rollator; and
a first torque output module for reducing the torque output of the motor, when the attitude indicates that the front end of the intelligent rollator is tilted upward, and the moving speed of the intelligent rollator is less than a first threshold;
a tilt protection module for reducing or stopping the increase of the torque output of the motor when the upward tilt angle of the intelligent rollator is greater than a preset maximum threshold.

21. A control device for an intelligent rollator having a vehicle body, a front wheel and rear wheels driven by a motor, comprising:
a second mode switch module for entering an intelligent crossing-curb mode according to preset trigger command;
a second movement speed acquisition module for obtaining the moving speed of an intelligent rollator;
a second attitude acquisition module for obtaining the attitude of an intelligent rollator; and
a second torque output module for controlling the torque output of the motor according to the upward tilt angle of the intelligent rollator, the larger the angle, the larger the torque output, when the attitude indicates that the front end of the intelligent rollator is tilted upward, and the moving speed of the intelligent rollator is less than a first threshold.

22. An intelligent rollator, comprising:
at least one memory and at least one processor;
one or more programs stored in the memory,
wherein the one or more programs are executed by the at least one processor to implement the steps of a control method for an intelligent rollator according to claim 13.

23. A controller, comprising:
at least one memory and at least one processor;
wherein the one or more programs are executed by the at least one processor to implement the steps of a control method for an intelligent rollator according to claim 13.
